(19) United States
(12) Patent Application Publication
(10) Pub. No.: US 2008/0186810 A1
(43) Pub. Date: Aug. 7, 2008

(54) System and Method for Audiovisual Content Search

(76) Inventor: O.R. Senthil Kumaran, Bangalore (IN)

Correspondence Address: HAMILTON & TERRILE, LLP, P.O. BOX 203518, AUSTIN, TX, 78720, US

(21) Appl. No.: 11/671,535

(22) Filed: Feb. 6, 2007

(51) Int. Cl. G11B 21/08

(52) U.S. Cl. 369/30.08

(57) ABSTRACT

Audiovisual content stored on an optical medium is searched for presentation of desired visual frames by indexing and analyzing subtitles associated with the visual frames. A subtitle index engine retrieves subtitles from the audiovisual content and maps the subtitles to associated visual frames. A subtitle search engine applies search queries to the subtitle index to identify frames having associated subtitles with a predetermined relationship. The subtitle index engine and subtitle search engine are present on an optical medium, such as a BD medium. The index and search engines are design for execution in an application framework associated with the optical medium, such as JAVA working with a JAVA application programming interface.

### BACKGROUND OF THE INVENTION

1. Field of the Invention

The present invention relates in general to the field of storing and retrieving information with an information handling system, and more particularly to a system and method for audiovisual content search.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling system users are increasingly relying on information handling systems as multimedia entertainment devices. High quality integrated LCDs make portable information handling systems ideal for presenting movies, such as with DVD media that store high quality audiovisual information. The introduction of blue laser optical media, such as Blu-Ray Disc (BD) media, and next generation DVD formats, such as High Definition DVD (HD DVD) media, will further enhance the attractiveness of information handling systems as entertainment devices. Large storage capacities in excess of 20 GB support storage of movies with high definition resolution as well as other additional features. An example of an additional feature is the JAVA based Application Programming Framework which executes applications read from a BD medium on a processor of a BD player, such as a processor of an information handling system. Executables retrieved from a media provide application programming framework support from a BD itself that enhances end user interactivity with content stored on a BD. In contrast, older optical media support only limited interactivity with content, such as the selection of a song, the selection of a video frame or other menu-based interactions. A typical DVD will store a movie, extra features, subtitles in various languages and a menu that breaks the movie down into a series of chapters. To view a desired portion of a movie in a DVD, an end user typically must remember the chapter in which the desired content is located and access the chapter with tags inserted in the DVD. CDs typically do not include any interactivity.

### SUMMARY OF THE INVENTION

Therefore a need has arisen for a system and method which searches visual information stored on an optical medium.

In accordance with the present invention, a system and method are provided which substantially reduce the disadvantages and problems associated with previous methods and systems for searching visual information stored on an optical medium. Subtitles associated with audiovisual content stored on an optical medium are retrieved and indexed to map each subtitle to one or more visual frames of the audiovisual content. A search query is applied to the subtitle index to identify audiovisual content having a predetermined relationship to the search query so that an end user can search audiovisual content to locate visual frames based upon audio information presented with the visual frames as represented by the subtitles.

More specifically, an information handling system retrieves audiovisual content from an optical medium for presentation at a display and speakers. A subtitle index engine retrieves subtitles from the audio visual content and maps the subtitles to associated visual frames in a subtitle index. The subtitle index engine provides the subtitle index to a subtitle search engine, which accepts subtitle queries to search for terms in the subtitle index. In one embodiment, the subtitle index engine and subtitle search engine are stored on the optical medium and retrieved to an information handling system for execution through a defined application framework, such as the BD Java application framework. The subtitle search engine applies the search query to the subtitle index to identify visual frames of the audiovisual content that have a predetermined relationship to search terms of the search query. For example, frames having a subtitle with one or more search terms are assigned a frameweight value and then presented in order of the frameweight values in response to the search query. An end user can select from the identified frames to play the audio visual content, thus allowing a search for desired visual content based on associated audio content and its subtitle content.

The present invention provides a number of important technical advantages. One example of an important technical advantage is that searches for visual information stored on an optical medium are performed by searching text from subtitles associated with the visual information. A media-based executable, such as an executable running in the BD Java Application Framework, provides a software player with access to a search feature without implementation in hardware of a player itself at the Application End based on the operating system. This media-based executable enables a search facility on an information handling system through its operating system as well as on set top boxes, such as BD players. End users who desire to view visual information associated with selected lines of speech enter the speech as a search term. Segments of visual information that meet the search criteria are presented to the end user for selection of a desired segment to play. Thus, an end user can quickly select a video segment to play based on the end user's recall of audio associated with the video segment.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having audiovisual content search support;

FIG. 2 depicts a flow diagram of a process for searching audiovisual content stored on an optical medium; and

FIG. 3 depicts a flow diagram of a process for analyzing a subtitle index to compute frameweights of subtitles associated with visual frames.

### DETAILED DESCRIPTION

Searching audiovisual content with an information handling system is supported by indexing subtitles of the audiovisual content mapped to visual frames so that a search of audio content through the subtitles identifies desired visual content. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

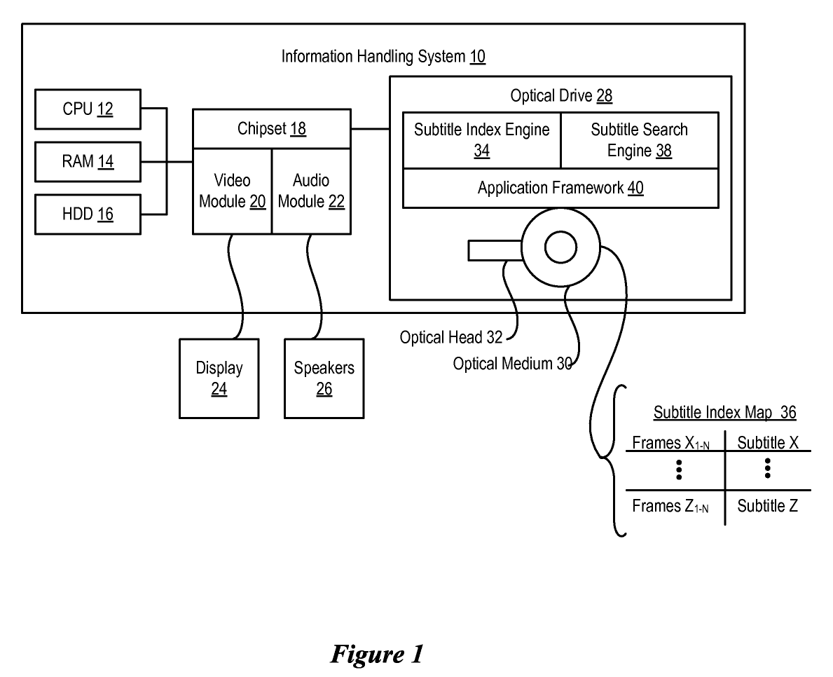

Referring now to FIG. 1, a block diagram depicts an information handling system 10 having audiovisual content search support. Information handling system 10 has plural processing components operable to cooperate to process audiovisual information for presentation to an end user. For example, a CPU 12, RAM 14, hard disk drive 16 and chipset 18 cooperate to run one or more applications that generate audiovisual information. Chipset 18 includes a video module 20 that communicates visual information to a display 24 for presentation as visual images and an audio module 22 that communicates audio information to a speaker 26 for presentation as audible sounds. An optical drive 28 interfaces with the processing components to provide one source of audiovisual information, such as audiovisual content stored on an optical medium 30. Optical drive 28 spins optical medium 30 relative to an optical head 32 to read information by alterations in the reflectivity of optical medium 30 when illuminated by a laser, such as an infrared laser for CD media, a red laser for DVD media, or a blue laser for BD or HD-DVD media. The audiovisual information includes visual frames of information presented as video on display 24, audio information presented as audible sounds at speakers 26, and subtitles that textually represent the audible information with text presented in visual frames substantially synchronized with the presentation of the audible sounds.

In order to support a search capability for visual frames from the audiovisual content on optical medium 30, a subtitle index engine 34 generates a subtitle index map 36 searchable by a subtitle search engine 38 so than an end user can find a desired video frame by reference to the audio subtitle associated with the visual frame. As an example, subtitle index engine 34 and subtitle search engine 38 are stored on optical medium 30 and retrieved for execution at information handling system 10 through an application framework 40 supported by optical drive 28, such as the BD Java application framework. Subtitle index engine 34 generates subtitle index map 36 by traversing through optical medium 30 in a passive mode with subtitle reading on to create a database of subtitles with a corresponding map of each subtitle to visual frames at which the subtitles are depicted in the visual content. Subtitle index engine 34 stores subtitle index map 36 in memory accessible by subtitle search engine 38, such as on optical medium 30, on persistent memory of information handling system 10 or in non-persistent memory. Subtitle search engine 38 accepts a search query from a user, such as through a user interface presented by display 24, and executes a search of subtitle index map 36 for visual frames having subtitles with a predetermined relationship to the search query. After the search query is applied, subtitle search engine 38 presents the visual frames in a predetermined order for presentation to the end user in response to the search query.

As one example, subtitle search engine 38 uses a frameweight approach to identify and order visual frames for presentation in response to a search query. For each subtitle, the frame or frames associated with the subtitle are assigned a frameweight value based on a comparison of the subtitle and the search query. An exact match between the search query and at least a portion of a subtitle assigns the highest value to the frame. A partial match of one or more search terms found in the search query to one or more terms of the subtitle results in a frameweight value based upon the number of search terms that match subtitle terms. As an example, a search query of “we are dead” that has an exact match in a subtitle would result in a frameweight value for the frames associated with the subtitle of the sum of the number of match words, in this case three, time a value of two for a total value of six. After searching for an exact match, the search query is broken into search terms, such as with the following Pseudo code:

>>> def getsearchterm(query):
searchterms = [ ]
for eachWord in set(query):
searchterms.append(eachWord)

Next a search for matches between search terms and subtitle terms is performed to assign frameweight values to frames, such as with the following Pseudo code:

>>> def frameweight(query,searchterms,frameindexdb):
if query in frameindexdb.keys( ):
frameindexdb[query].frameweight = getvalue(exactmatch)
else:
for eachterm in searchterms:
frameindexdb[eachterm].frameweight = getvalue(eachterm)

Thus, using the above example, a subtitle having the phrase “dead man's chest” would have a single match for a frameweight value of 1. Once the search query and its search terms are applied to each subtitle of subtitle index map 36, frames having a frameweight value are presented at display 24 in order of the frameweight values. For instance, the frames are presented as thumb icons selectable by an end user to present the audiovisual content starting from the frame having the matching subtitle phrase or terms.

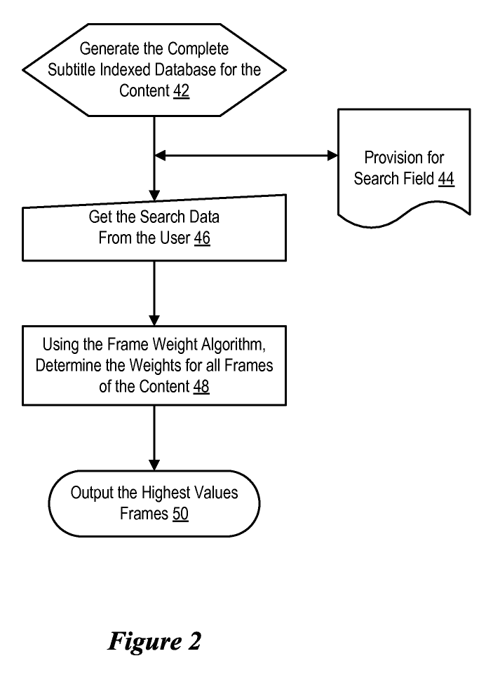

Referring now to FIG. 2, a flow diagram depicts a process for searching audiovisual content stored on an optical medium. The process begins at step 42 with generation of a complete subtitle indexed database for the audiovisual content, such as a movie stored on an optical medium. At step 44, a provision is made to accept a search query from an end user. At step 46, the search query data is accepted from the end user for application to the subtitle indexed database. At step 48, frameweight values are assigned to the frames of the audiovisual content based on the subtitles associated with the frames. At step 50, the frameweight values are ordered from highest to least for presentation to the end user. Although the computation of frameweights provides a convenient and rapid search for desired terms, in alternative embodiments, alternative search algorithms may be applied.

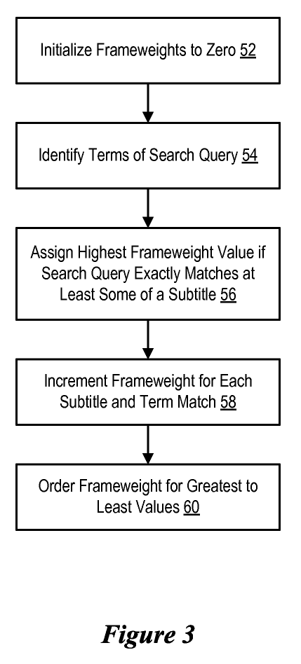

Referring now to FIG. 3, a flow diagram depicts a process for analyzing a subtitle index to compute frameweights of subtitles associated with visual frames. At step 52, the frameweight values are initialized to zero. At step 54, the terms of the search query are broken out and identified for application to the subtitle index. At step 56, the highest available frameweight value is assigned to each subtitle having an exact match with the search query considered as a whole. At step 58, the frameweight value for each subtitle is incrementally increased for each match between a subtitle term and search term. At step 60, once all of the frameweights are computed, the frames are ordered by frameweight value for presentation in response to the search query. Based on the frameweight order, the end user can select presentation of the audiovisual content to view visual frames based upon the audio content as represented by the subtitles associated with the visual frames.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to process visual and audio information;
an optical drive interfaced with the processing components and operable to retrieve visual and audio information from an optical medium;
a subtitle index engine operable to index subtitles associated with the visual and audio information; and
a subtitle search engine operable to accept a search query and apply the search query to the subtitle index to retrieve video and audio information related to the search query.

2. The information handling system of claim 1 wherein the subtitle index engine comprises an application stored on the optical medium and retrieved by the optical drive to run on the processing components.

3. The information handling system of claim 2 wherein the subtitle index engine is further operable to store the subtitle index in persistent memory associated with the processing components.

4. The information handling system of claim 2 wherein the subtitle index engine is further operable to store the subtitle index on the optical medium.

5. The information handling system of claim 1 wherein the subtitle search engine searches the subtitle index based at least in part on a frame weight.

6. The information handling system of claim 5 wherein the subtitle search engine presents search query results in order of the frame weight associated with the subtitles.

7. The information handling system of claim 1 wherein the optical medium comprises a blue laser medium.

8. A method for audiovisual content search, the audiovisual content having plural subtitles, each subtitle presented at one or more visual frames, the method comprising:
generating a subtitle index for the audiovisual content, the subtitle index having each subtitle associated with one or more visual frames;
accepting a search query having one or more search terms;
applying the search terms to the subtitle index to identify one or more visual frames having subtitles with a predetermined relationship to the search terms; and
presenting the identified visual frames in response to the search query.

9. The method of claim 8 wherein the audiovisual content comprises an optical medium and generating a subtitle index comprises retrieving the subtitles from the optical medium.

10. The method of claim 9 further comprising:
retrieving a subtitle index engine from the optical medium to an information handling system; and
executing the subtitle index engine on the information handling system to perform the generating a subtitle index.

11. The method of claim 10 further comprising storing the subtitle index on the optical medium.

12. The method of claim 8 further comprising storing the subtitle index on persistent memory of an information handling system.

13. The method of claim 9 further comprising:
retrieving a subtitle search engine from the optical medium to an information handling system; and
executing the subtitle search engine on the information handling system to perform the applying the search terms.

14. The method of claim 8 wherein applying the search terms further comprises:
identifying an exact match between the search query and at least part of a subtitle; and
presenting the visual frames associated with the subtitle.

15. The method of claim 8 wherein applying the search terms further comprises:
computing a frameweight value for each subtitle by comparing the search terms with the subtitle; and
presenting visual frames in order of the frameweight values for the subtitle associated with the visual frames.

16. A system for audiovisual content search, the system comprising:
a subtitle index engine operable to retrieve subtitles from the audiovisual content and to map each subtitle to associated visual frames in a subtitle index; and
a subtitle search engine operable to apply a search query to the subtitle index to identify visual frames having subtitles with a predetermined relationship to the search query.

17. The system of claim 16 wherein the predetermined relationship comprises a frameweight.

18. The system of claim 16 wherein the audiovisual content comprises an optical medium and the subtitle index engine and subtitle search engine comprise applications stored on the optical medium and retrievable by an information handling system for execution.

19. The system of claim 18 wherein the subtitle index engine is further operable to store the subtitle index on the optical medium.

20. The system of claim 18 wherein the subtitle index engine is further operable to store the subtitle index on persistent memory of the information handling system.
